(19) United States
(12) Patent Application Publication
(10) Pub. No.: US 2005/0013081 A1
(43) Pub. Date: Jan. 20, 2005

(54) Electronic appliance switch adapter

(76) Inventor: Daniel A. Gilbert, Boise, ID (US)

Correspondence Address: Joseph W. Holland;HOLLAND & THIEL, P.C., PO Box 1840, Boise, ID, 83701-1840, US

(21) Appl. No.: 10/622,902

(22) Filed: Jul. 17, 2003

(51) Int. Cl. H01H 73/00

(52) U.S. Cl. 361/115

(57) ABSTRACT

A power cord switch adapter including a switch housing, a switch housed within the switch housing, a first connector/conductor end conductively connected to the switch, a second connector/conductor end conductively connected to the switch. The power cord switch adapter may also include an attachment member connected to the switch housing, for attaching the power cord switch adapter to an electronic appliance, for instance an imaging device.

### BACKGROUND OF THE INVENTION

1. Technical Field:

The present invention relates generally to imaging devices and more particularly to a switch adapter for an imaging device.

2. Background Art:

In an attempt to reduce cost of production and manufacture of various electronic appliances, for example imaging devices, have eliminated a switch for power to the device. As shown in FIG. 1, according to current designs for some imaging devices, imaging device 5 includes a power cord 6 that attaches, unswitched, directly to the imaging device 5 by means of a power cord 6 which is conductively connected to a first end to a power source PS and to the imaging device 5 at plug socket 8 by female connector/conductor end 7.

It may be advantageous to provide a switch adapter that permits the conductive connection of a switch in series with the power cord of an electronic appliance, for example, an imaging device.

### SUMMARY OF THE INVENTION

The present invention is directed to a power cord switch adapter for an electronic appliance, for example, an imaging device, the power cord switch adapter including a switch housing having a switch housed within the switch housing. The power cord switch adapter also includes a first connector/conductor end and a second connector/conductor end conductively connected to the first connector/conductor end and switchable between an on and an off position by the switch. In one preferred embodiment the power cord switch adapter also includes an attachment member connected to the switch housing, the attachment member adapted to attach the switch housing to the electronic appliance.

In one preferred embodiment of the invention, the first connector/conductor end may be configured as an electronic appliance male connector/conductor end, which in one preferred embodiment is configured consistent with the standards of the International Electrotechnical Commission, (IEC). Similarly, the second connector/conductor end may be configured as an electronic appliance female connector/conductor end, configured consistent with the standards of the International Electrotechnical Commission, (IEC). In one preferred embodiment of the invention, the first connector/conductor end is incorporated as a portion of the switch housing. In an alternate one preferred embodiment of the invention, the power cord switch adapter also includes a conductor, for example a power cord, conductively connected between the switch and the second connector/conductor end.

In one preferred embodiment of the invention, the power cord switch adapter attachment member includes joinable hook and loop fastener portions, one portion attached to the switch housing and the opposing connecting portion attached to the electronic appliance. Alternately, the attachment member may be configured as a magnetic fastener, an adhesive fastener, a mechanical fastener or may be attached by other means known to those skilled in the art.

An alternate preferred embodiment of the invention includes an imaging device including an imaging device housing and a power cord switch adapter attachable to the imaging device housing, the power cord switch adapter including a switch housing, a switch housed within the switch housing, an electronic appliance male end power cord socket connected to the housing and conductively connected to the switch, the electronic appliance male end power cord socket including one or more male IEC computer power cord blade conductors, an electronic appliance female end power cord socket conductively connected to the switch, the electronic appliance female end power cord socket including one or more female IEC computer power cord socket conductors and an attachment member connected to the switch housing, the attachment member attachable between the switch body and the imaging device housing.

### BRIEF DESCRIPTION OF THE DRAWINGS

FIG. 1 is a perspective representation of an imaging device according to the prior art.

FIG. 2 is perspective representation of an imaging device including a power cord switch adapter according to one embodiment of the invention.

FIG. 3 is perspective representation of a power cord switch adapter according to one embodiment of the invention.

FIG. 4 is perspective representation of a power cord switch adapter according to one embodiment of the invention.

FIG. 5 is representational rear view of a power cord switch adapter according to one embodiment of the invention.

FIG. 6 is representational side view of a power cord switch adapter according to one embodiment of the invention.

FIG. 7 is representational front view of a power cord switch adapter according to one embodiment of the invention.

FIG. 8 is schematic representation of a circuit for a power cord switch adapter according to one embodiment of the invention.

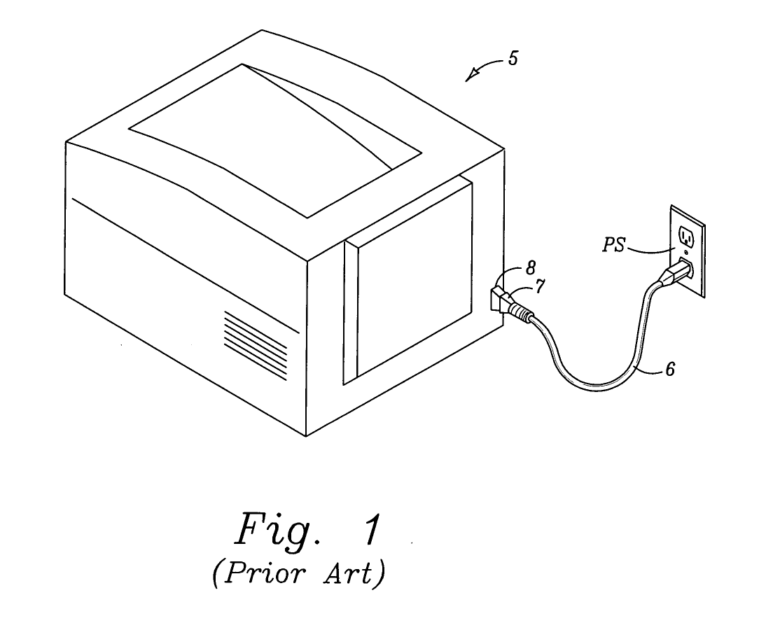

### DETAILED DESCRIPTION OF THE INVENTION

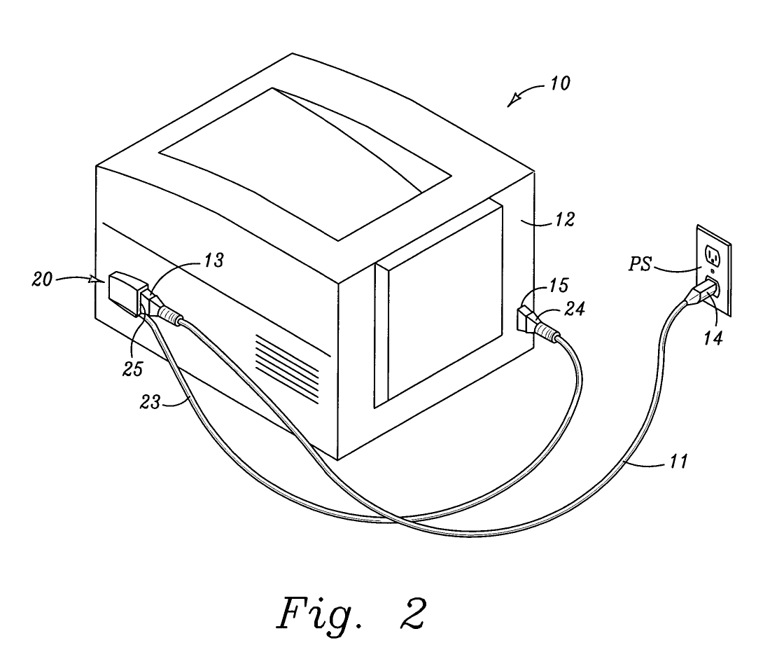

Referring to FIG. 2, imaging device 10 is shown. Power cord switch adapter 20 is shown attached to housing 12. Electrical power is provided to imaging device 10 by power cord 11. Power cord 11 includes male plug connector 14 and an electronic appliance female connector/conductor end 13. Plug connector 14 is shown connected to power source PS. As shown, female connector/conductor end 13 is configured as a female IEC computer power cord socket connector/conductor and is shown conductively connected to male connector/conductor end power cord socket 25 of power cord switch adapter 20. Power lead conductor 23 conductively connects power lead female connector/conductor end 24 to power cord switch adapter 20. As shown, power cord switch adapter 20 is conductively connected to imaging device 10 at plug socket 15 by power lead female connector/conductor end 24.

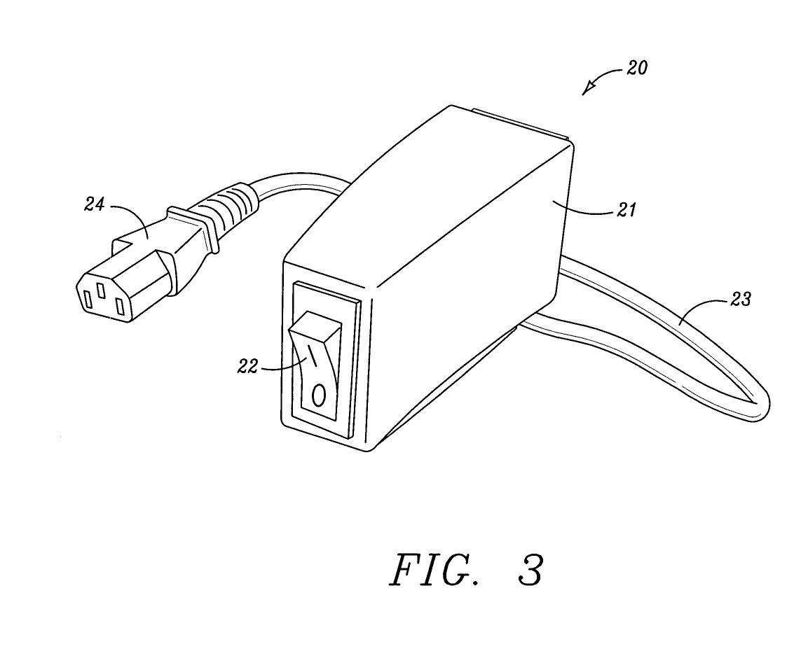

Referring to FIG. 3, power cord switch adapter 20 is shown including switch housing 21 and power lead female connector/conductor end 24 conductively connected by power lead conductor 23. Power cord switch adapter 20 includes switch 22.

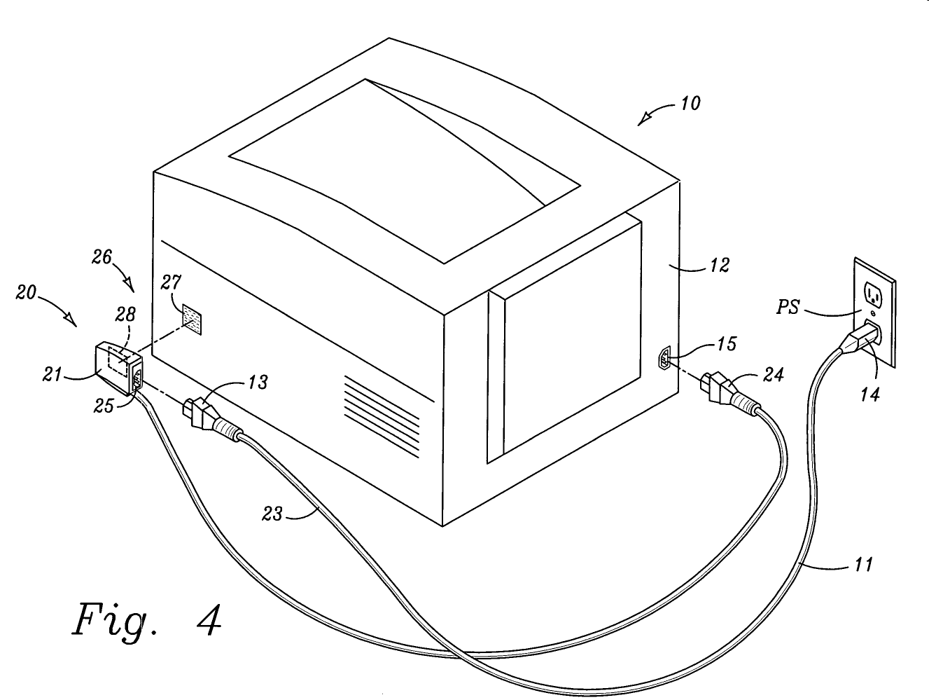

Referring to FIG. 4, power cord switch adapter 20, including switch housing 21, is shown positioned for attachment to housing 12. Electrical power is provided to imaging device 10 by power cord 11. Power cord 11 includes male plug connector 14 and an electronic appliance female connector/conductor end 13. Plug connector 14 is shown connected to power source PS. As shown, female connector/conductor end 13 is positioned for conductive connection to male connector/conductor end power cord socket 25 of power cord switch adapter 20. Power lead conductor 23 conductively connects power lead female connector/conductor end 24 to power cord switch adapter 20. As shown, power lead female connector/conductor end 24 is positioned for conductive connection to imaging device 10 at plug socket 15. Attachment member 26 is shown including joinable hook and loop fastener first portion 27 attached to imaging device housing 12 and hook and loop fastener second portion 28, attached to switch housing 21. and the opposing connecting portion attached to the electronic appliance. Joinable hook and loop fastener first portion 27 and hook and loop fastener second portion 28 are shown positioned for cooperative connection, each to the other to effect attachment of switch housing 21 to imaging device housing 12.

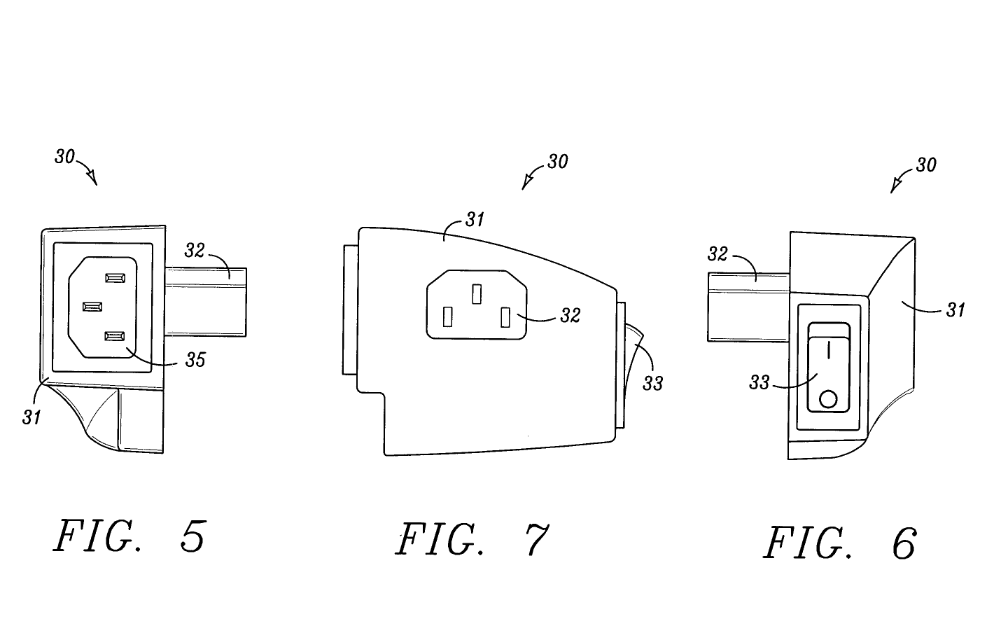

FIGS. 5 through 7 show an alternate embodiment of power cord switch adapter 30 including switch housing 31. As seen in FIG. 5, power cord switch adapter 30 includes connector/conductor end power cord socket 35 which in the embodiment shown is incorporated within switch housing 31. As seen in FIG. 6, power cord switch adapter 30 includes switch 33. As shown in FIG. 5, 6 and 7, power cord switch adapter 30 includes power lead female connector/conductor end 32 which attaches directly to switch housing 31.

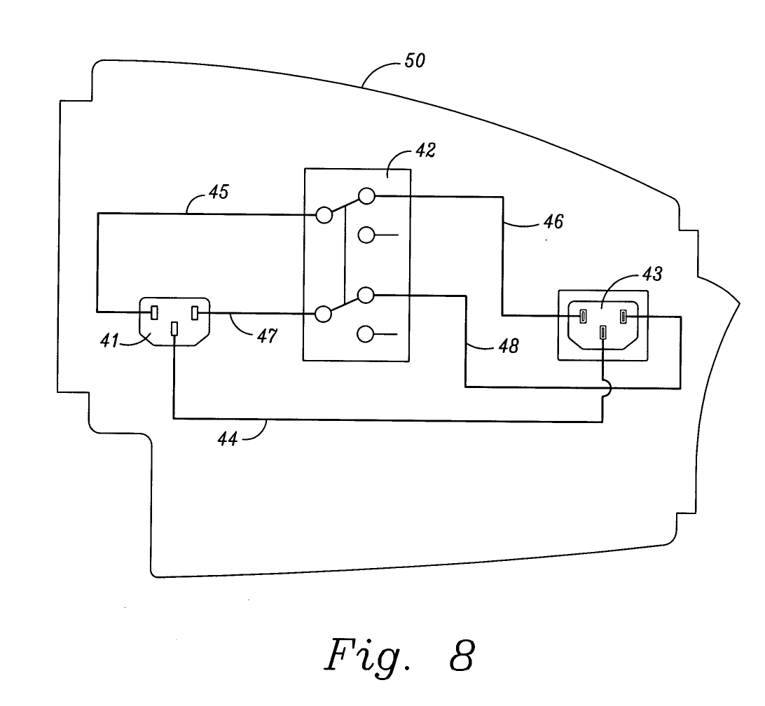

FIG. 8 is schematic representation of power cord switch adapter 50 including connector/conductor end power cord socket 41 conductively connected through switch 42 to power lead female connector/conductor end 43 by conductors 44, 45, 46, 47 and 48.

While this invention has been described with reference to the detailed embodiments, this is not meant to be construed in a limiting sense. Various modifications to the described embodiments as well as the inclusion or exclusion of additional embodiments will be apparent to persons skilled in the art upon reference to this description. It is therefore contemplated that the appended claims will cover any such modifications or embodiments as fall within the true scope of the invention.

1. A power cord switch adapter for an electronic appliance comprising:
a switch housing;
a switch housed within the switch housing;
a first connector/conductor end conductively connected to the switch; and
a second connector/conductor end conductively connected to the switch.

2. The power cord switch adapter of claim 1 further comprising an attachment member connected to the switch housing, for attaching the switch housing to the electronic appliance.

3. The power cord switch adapter of claim 1 wherein the first connector/conductor end further comprises an electronic appliance male end power cord socket conductively connected to the switch.

4. The power cord switch adapter of claim 1 wherein the second connector/conductor end further comprises an electronic appliance female end power cord socket conductively connected to the switch.

5. The power cord switch adapter of claim 1 further comprising a conductor connected between the switch and the second connector/conductor end.

6. The power cord switch adapter of claim 2 wherein the attachment member attachable between the switch housing and the electronic appliance further comprises joinable hook and loop fastener portions.

7. The power cord switch adapter of claim 2 wherein the attachment member attachable between the switch housing and the electronic appliance further comprises a magnetic fastener.

8. The power cord switch adapter of claim 2 wherein the attachment member attachable between the switch housing and the electronic appliance further comprises an adhesive fastener.

9. The power cord switch adapter of claim 2 wherein the attachment member attachable between the switch housing and the electronic appliance further comprises an adhesive fastener.

10. The power cord switch adapter of claim 2 wherein the attachment member attachable between the switch housing and the electronic appliance further comprises a mechanical fastener.

11. A power cord switch adapter for an electronic appliance comprising:
a switch housing;
a switch housed within the switch housing;
an electronic appliance male connector/conductor end power cord socket connected to the housing and conductively connected to the switch, the electronic appliance male connector/conductor end power cord socket including one or more male IEC computer power cord blade conductors; and
an electronic appliance female connector/conductor end conductively connected to the switch, the electronic appliance female connector/conductor end including one or more female IEC computer power cord socket conductors.

12. The power cord switch adapter of claim 11 further comprising an attachment member connected to the switch housing, for attaching the switch housing to the electronic appliance.

13. The power cord switch adapter of claim 11 further comprising a conductor connected between the switch and the electronic appliance female connector/conductor end.

14. The power cord switch adapter of claim 12 wherein the attachment member attachable between the switch housing and the electronic appliance further comprises joinable hook and loop fastener portions.

15. The power cord switch adapter of claim 12 wherein the attachment member attachable between the switch housing and the electronic appliance further comprises a magnetic fastener.

16. The power cord switch adapter of claim 12 wherein the attachment member attachable between the switch housing and the electronic appliance further comprises an adhesive fastener.

17. The power cord switch adapter of claim 12 wherein the attachment member attachable between the switch housing and the electronic appliance further comprises an adhesive fastener.

18. An imaging device comprising:
an imaging device housing; and
a power cord switch adapter attachable to the imaging device housing, the power cord switch adapter including a switch housing, a switch housed within the switch housing, an electronic appliance male connector/conductor end power cord socket connected to the housing and conductively connected to the switch, the electronic appliance male connector/conductor end power cord socket including one or more male IEC computer power cord blade conductors and an electronic appliance female connector/conductor end conductively connected to the switch, the electronic appliance female connector/conductor end including one or more female IEC computer power cord socket conductors.

19. The imaging device of claim 18 wherein the power cord switch adapter further comprises an attachment member connected to the switch housing, for attaching the switch housing to the electronic appliance.

20. The imaging device of claim 18 wherein the power cord switch adapter further comprises a conductor connected between the switch and the electronic appliance female connector/conductor end.

21. The power cord switch adapter of claim 18 wherein the attachment member attachable between the switch housing and the electronic appliance further comprises joinable hook and loop fastener portions.

22. The power cord switch adapter of claim 19 wherein the attachment member attachable between the switch housing and the electronic appliance further comprises a magnetic fastener.

23. The power cord switch adapter of claim 19 wherein the attachment member attachable between the switch housing and the electronic appliance further comprises an adhesive fastener.

24. The power cord switch adapter of claim 19 wherein the attachment member attachable between the switch housing and the electronic appliance further comprises an adhesive fastener.
